(19) United States
(12) Patent Application Publication
(10) Pub. No.: US 2025/0087956 A1
(43) Pub. Date: Mar. 13, 2025

(54) SOLAR CABLE DECOUPLER TOOL AND RELATED METHOD

(71) Applicant: Fluke Corporation, Everett, WA (US)

(72) Inventors: Summer T. Scales, Everett, WA (US); Francis M. Zapf, Everett, WA (US); Duncan N. Kearsley, Everett, WA (US)

(21) Appl. No.: 18/828,766

(22) Filed: Sep. 9, 2024

Related U.S. Application Data
(60) Provisional application No. 63/581,345, filed on Sep. 8, 2023.

(51) Int. Cl. H01R 43/26; B25B 27/14

(52) U.S. Cl. CPC H01R 43/26; B25B 27/14

(57) ABSTRACT

In one aspect, a solar cable decoupler tool includes a main body and a tool member couplable to the main body. The tool member is movable relative to the main body between a retracted position and an extended position. The tool member is configured to be inserted into a solar cable connector to decouple first and second solar cables.

### RELATED APPLICATIONS

The present application claims the benefit of priority from U.S. Application No. 63/581,345, entitled, SOLAR CABLE DECOUPLER TOOL AND RELATED METHOD,” filed Sep. 8, 2023, the entirety of which is incorporated by reference herein.

### FIELD

The present disclosure relates generally to a solar cable decoupler tool for disconnecting solar cables. In particular, the present disclosure is related to solar cable decoupler tool having a main body and a tool member movable relative to the main body, with the tool member being insertable into a solar cable connector to disconnect or decouple solar cables from each other. The present disclosure also relates to a related method of using the solar cable decoupler tool to decouple solar cables.

### BACKGROUND

Solar is an emerging industry having new components, cables, and connectors that require specialized tools. Solar cables may electrically connect one or more components in a photovoltaic system (which may include one or more solar panels). Generally, a first solar cable and a second solar cable are coupled to one another (e.g., electrically and mechanically) via a solar cable connector. The first solar cable typically includes the male end of the solar cable connector, and the second solar cable includes a female end of the solar cable connector or vice versa. The male end includes one or more prongs that extend into a slot defined in the female end to couple the first solar cable to the second solar cable.

Currently, solar tools exist for decoupling solar cables, which include fixed forks permanently protruding from a body. The forks may be inserted into the cable connector to disconnect the male and female ends of the solar cable connector, thereby decoupling the solar cables. However, issues exist with the design of such solar tools. For example, by configuring the forks to permanently extend outwardly from the body in a protruding manner, the user may be harmed and/or have their clothing damaged when storing the solar tool in their pocket. Additionally, because the forks needed to disconnect the cables are small, they can break easily during storage in a tool box and/or during operation, often causing the user to have to obtain an entire replacement tool.

Accordingly, an improved solar cable decoupler tool that addresses one or more of the above issues is desired and would be appreciated in the art.

### BRIEF DESCRIPTION

Aspects and advantages of the solar cable decoupler tools and methods in accordance with the present disclosure will be set forth in part in the following description, or may be obvious from the description, or may be learned through practice of the technology.

In accordance with one embodiment, the present disclosure is directed to a solar cable decoupler tool for decoupling solar cables. The solar cable decoupler tool includes a main body and a tool member couplable to the main body. The tool member is movable relative to the main body between a retracted position and one or more extended positions. The tool member is configured to be inserted into a solar cable connector to decouple a first solar cable from a second solar cable that is connectable with the first solar cable via the solar cable connector.

In accordance with another embodiment, the present disclosure is directed to a method of using a solar cable decoupler tool for decoupling first and second solar cables connected together via a solar cable connector. The method includes moving a tool member of the solar cable decoupler tool relative to a main body of the solar cable decoupler tool from a retracted position to an extended position. The method further includes inserting the tool member into the solar cable connector to decouple the first solar cable from the second solar cable.

These and other features, aspects and advantages of the present solar cable decoupler tools and methods will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present solar cable decoupler tools and methods, including the best mode of making and using the present systems and methods, directed to one of ordinary skill in the art, is set forth in the specification, which makes reference to the appended figures, in which:

FIG. 1A illustrates a first step in a process for decoupling solar cables by utilizing a solar cable decoupler tool in accordance with an exemplary aspect of the present disclosure;

FIG. 1B illustrates a second step in a process for decoupling solar cables by utilizing a solar cable decoupler tool in accordance with an exemplary aspect of the present disclosure;

FIG. 2 illustrates an exploded perspective view of a solar cable decoupler tool in accordance with embodiments of the present disclosure;

FIG. 3 illustrates a perspective view of a first side of a solar cable decoupler tool, in which a first tool member is in a retracted position, in accordance with embodiments of the present disclosure;

FIG. 4 illustrates a perspective view of a first side of the solar cable decoupler tool from FIG. 3, in which the first tool member is in a first extended position, in accordance with embodiments of the present disclosure;

FIG. 5 illustrates a perspective view of a first side of the solar cable decoupler tool from FIG. 3, in which the first tool member is in a second extended position, in accordance with embodiments of the present disclosure;

FIG. 6 illustrates a perspective view of a second side of a solar cable decoupler tool, in which a second tool member is in a retracted position, in accordance with embodiments of the present disclosure;

FIG. 7 illustrates a perspective view of a second side of the solar cable decoupler tool from FIG. 6, in which the second tool member is in an extended position, in accordance with embodiments of the present disclosure;

FIG. 8 illustrates a plan view of a first side of a solar cable decoupler tool, in accordance with embodiments of the present disclosure;

FIG. 9 illustrates a plan view of a second side of a solar cable decoupler tool, in accordance with embodiments of the present disclosure;

FIG. 10 illustrates a cross-sectional view of the solar cable decoupler tool 100 taken along line 10-10 shown in FIG. 8, in accordance with embodiments of the present disclosure;

FIG. 11 illustrates an enlarged plan view of a second side of the solar cable decoupler tool, in which the first tool member is in a first extended position (e.g., the position shown in FIG. 4), in accordance with embodiments of the present disclosure;

FIG. 12 illustrates an enlarged plan view of a second side of the solar cable decoupler tool, in which the first tool member is in a transitory position between the first extended position (e.g., the position shown in FIG. 4) and the retracted position (e.g., the position shown in FIG. 3), in accordance with embodiments of the present disclosure;

FIG. 13 illustrates a cross-sectional view of the solar cable decoupler tool taken along line 13-13 shown in FIG. 11, in accordance with embodiments of the present disclosure; and

FIG. 14 is a flow diagram of a method of using a solar cable decoupler tool for decoupling solar cables in accordance with embodiments of the present disclosure.

### DETAILED DESCRIPTION

Reference now will be made in detail to embodiments of the present solar cable decoupler tools and related methods, one or more examples of which are illustrated in the drawings. Each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components.

As used herein, the terms “upstream” (or “forward”) and “downstream” (or “aft”) refer to the relative direction with respect to fluid flow in a fluid pathway. For example, “upstream” refers to the direction from which the fluid flows, and “downstream” refers to the direction to which the fluid flows. However, the terms “upstream” and “downstream” as used herein may also refer to a flow of electricity. The term “radially” refers to the relative direction that is substantially perpendicular to an axial centerline of a particular component, the term “axially” refers to the relative direction that is substantially parallel and/or coaxially aligned to an axial centerline of a particular component and the term “circumferentially” refers to the relative direction that extends around the axial centerline of a particular component.

Terms of approximation, such as “about,” “approximately,” “generally,” and “substantially,” are not to be limited to the precise value specified. In at least some instances, the approximating language may correspond to the precision of an instrument for measuring the value, or the precision of the methods or machines for constructing or manufacturing the components and/or systems. In at least some instances, the approximating language may correspond to the precision of an instrument for measuring the value, or the precision of the methods or machines for constructing or manufacturing the components and/or systems. For example, the approximating language may refer to being within a 1, 2, 4, 5, 10, 15, or 20 percent margin in either individual values, range(s) of values and/or endpoints defining range(s) of values. When used in the context of an angle or direction, such terms include within ten degrees greater or less than the stated angle or direction. For example, “generally vertical” includes directions within ten degrees of vertical in any direction, e.g., clockwise or counter-clockwise.

The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

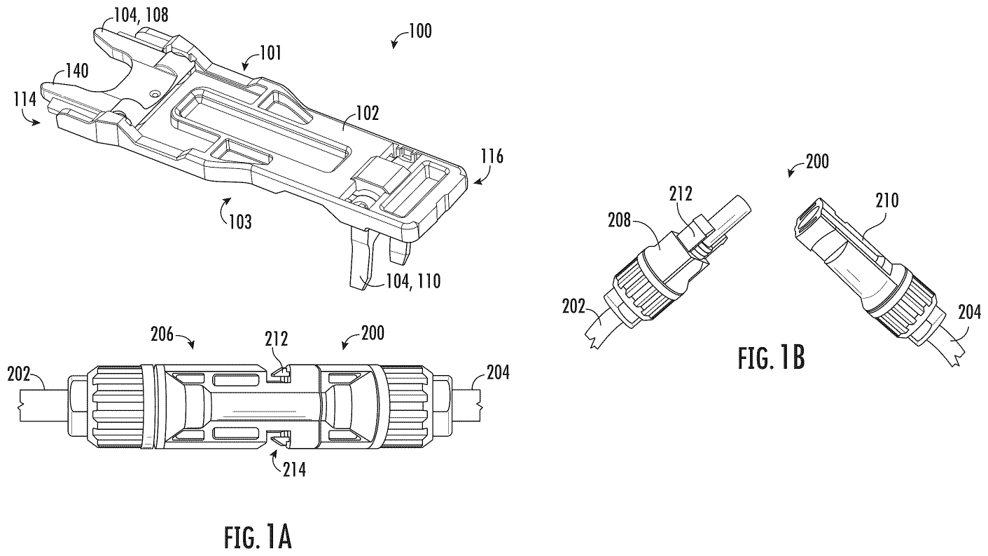

Referring now to the drawings, FIGS. 1A and 1B illustrate two steps in a process for decoupling solar cables 200 by utilizing a solar cable decoupler tool 100. The solar cables 200 may be electrically connectable to one or more components in a photovoltaic system (such as a solar panel or supporting components). Particularly, the solar cables 200 include a first solar cable 202 and a second solar cable 204 that are connectable to one another (e.g., electrically and mechanically) via a solar cable connector 206. A male end 208 of the solar cable connector 206 is coupled to the first solar cable 202, and a female end 210 of the solar cable connector 206 is coupled to the second solar cable 204. The male end 208 includes one or more prongs 212, and the female end 210 may define one or more slots 214. The one or more prongs 212 may be inserted into the one or more slots 214 to couple the male end 208 to the female end 210. In exemplary implementations, the solar cable connector 206 may be a Multi-Contact, 4 millimeters cable (“MC4”). The male end 208 may include a metal pin, while the female end 210 has a metal socket. When connected, the pin and socket form a tight electrical connection.

In accordance with aspects of the present subject matter, the disclosed he solar cable decoupler tool 100 may include a main body 102 and one or more tool members 104 coupled to the main body 102 (e.g., removably and rotatably or pivotably coupled to the main body 102). In several embodiments, the tool members 104 may have a forked configuration and may include tangs or arms 140 sized to be inserted into the one or more slots 214 of the solar cable connector 206 (e.g., the arms 140 may have a width that is smaller than a width of the slots 214). In order to decouple the solar cables 202, 204, the arms 140 of the tool member 104 may be into the slots 214 of the solar cable connector 206 (e.g., by a user grasping the main body 102 of the tool 100 and inserting the tool member 104 into the slots 214). A force may be applied by the arms 140 of the tool member 104 to the prongs 212 of the solar cable connector 206, which causes the prongs 212 to move out of the slots 214 so that the male end 208 can be disconnected from the female end 210, thereby decoupling the first and second solar cables 202, 204 from each other.

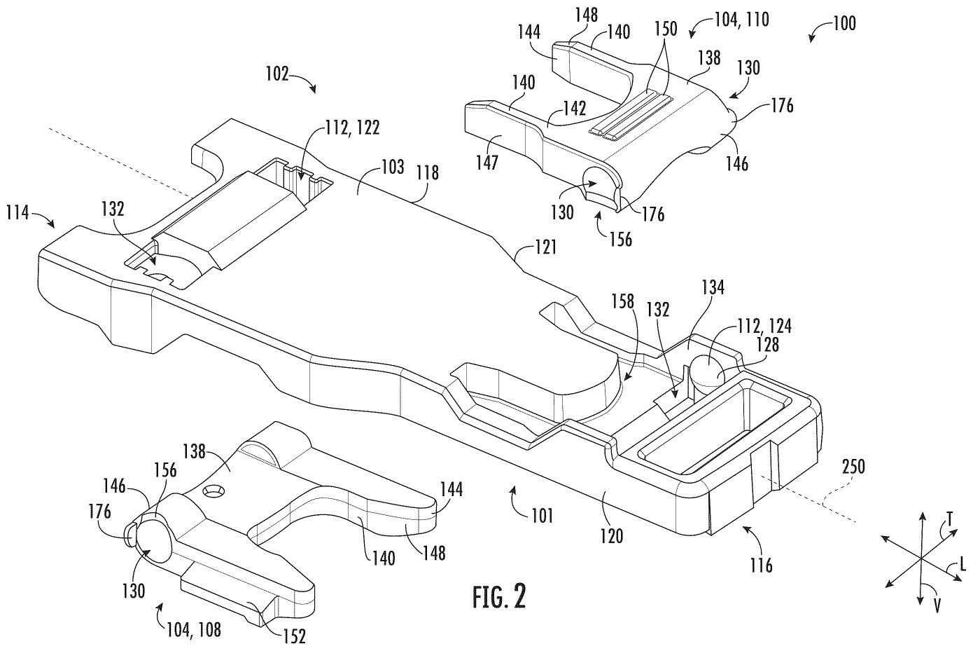

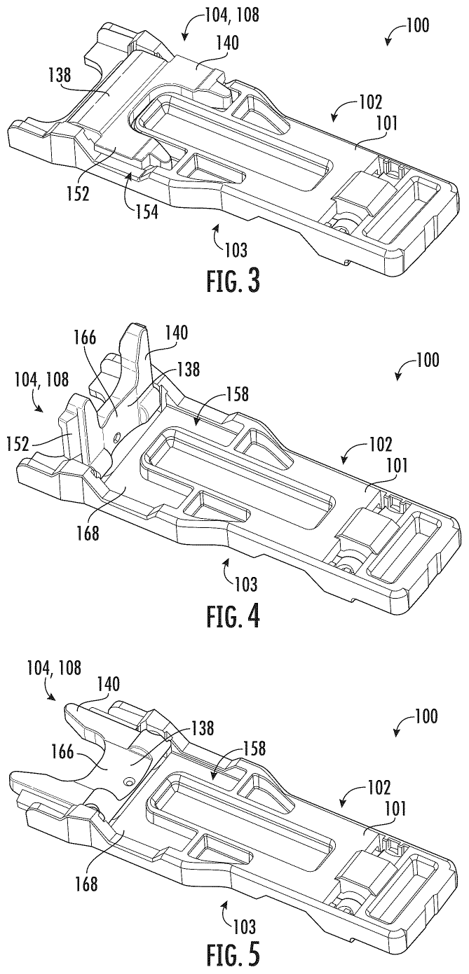

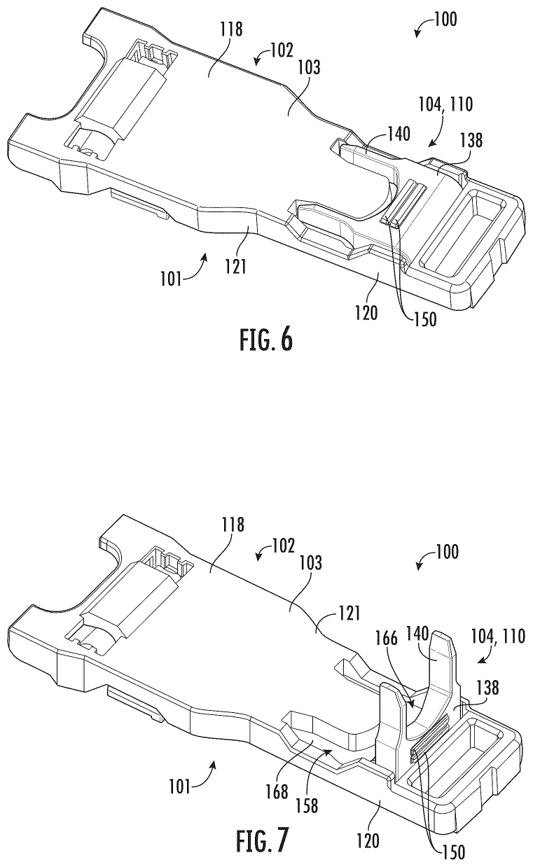

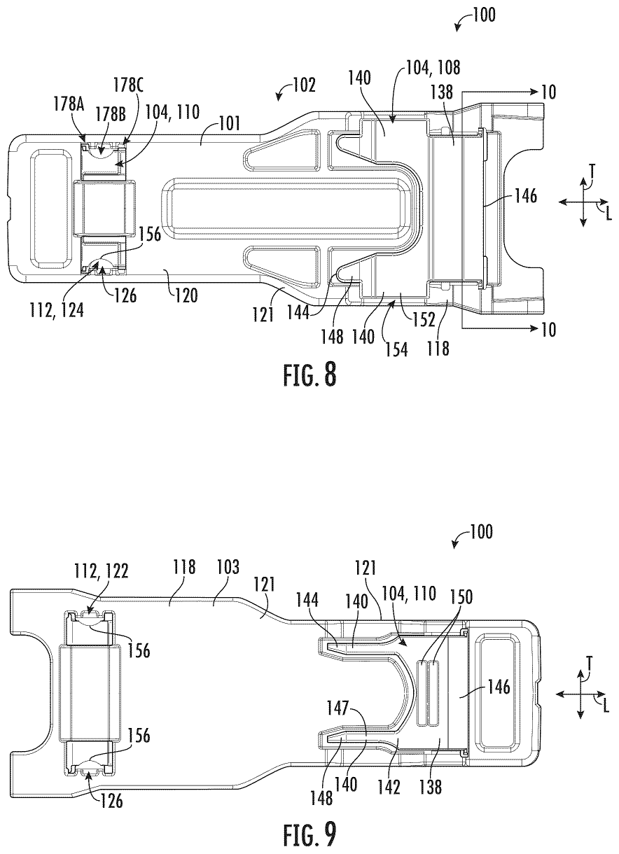

Referring now to FIGS. 2 through 9, various views of one embodiment of a solar cable decoupler tool 100 suitable to be used in accordance with the process described above with reference to FIGS. 1A and 1B are illustrated in accordance with embodiments of the present disclosure. Particularly, FIG. 2 illustrates an exploded perspective view of the solar cable decoupler tool 100. FIGS. 3-5 illustrate perspective views of a first side 101 of the solar cable decoupler tool 100, in which a first tool member 108 of the tool 100 is in a retracted position (FIG. 3), a first extended position (FIG. 4), and a second extended position (FIG. 5). FIGS. 6 and 7 illustrate perspective views of a second side 103 of the solar cable decoupler tool 100, in which a second tool member 110 of the tool 100 is in a retracted position (FIG. 6) and in an extended position (FIG. 7). Additionally, FIG. 8 illustrates a plan view of the first side 101 of the solar cable decoupler tool 100, while FIG. 9 illustrates a plan view of the second side 103 of the solar cable decoupler tool 100.

As particularly shown in FIG. 2, the solar cable decoupler tool 100 may define an orthogonal coordinate system having a longitudinal direction L extending along a longitudinal centerline 250 of the tool 100, a vertical direction V, and a transverse direction T, each of which is mutually perpendicular.

In general, the solar cable decoupler tool 100 includes a main body 102 and one or more tool members 104 (such as the first tool member 108 and the second tool member 110) couplable to the main body 102. In several embodiments, each tool member 104 is movable relative to the main body 102 between a retracted position and an extended position. Additionally, each tool member 104 is configured to be inserted into a solar cable connector to disconnect first and second solar cables (as discussed above with reference to FIGS. 1A and 1B).

The main body 102 may be a generally rectangularly shaped body. Particularly, as shown in FIG. 2, the main body 102 may extend (e.g., longitudinally) from a first end 114 to a second end 116. The main body 102 may be longest in the longitudinal direction L (i.e., elongated in the longitudinal direction L). As shown in in FIG. 2, the main body 102 may include a first portion 118 having a first width in the transverse direction T, a second portion 120 having a second width in the transverse direction T (which is smaller than the first width), and a tapering or converging portion 121 extending between the first portion 118 and the second portion 120.

In several embodiments, the main body 102 may define or include one or more coupling features 112 for coupling each tool member 108, 110 to the main body 102. Particularly, as shown in FIG. 2, the main body 102 may include a first coupling feature 122 defined in the first portion 118 of the main body 102 (e.g., on the first side 101 of the main body 102) for coupling the first tool member 108 to the main body 102 and a second coupling feature 124 defined in the second portion 120 of the main body 102 (e.g., on the second side 103 of the main body 102) for coupling the second tool member 110 to the main body 102. As shown in FIG. 2, the first tool member 108 may be disposed proximate (i.e., closer to) the first end 114 of the main body 102 while the second tool member 110 may be disposed proximate the second end 116 of the main body 102.

In exemplary embodiments, a ball and socket joint 126 may be formed between the main body 102 and each tool member 108, 110. In such embodiments, each coupling feature 122, 124 of the main body 102 may correspond to one of a ball 128 or a socket 130 of the ball and socket joint 126 while each respective tool member 108, 110 may define or include the other of the ball 128 or the socket 130 of the ball and socket joint 126.

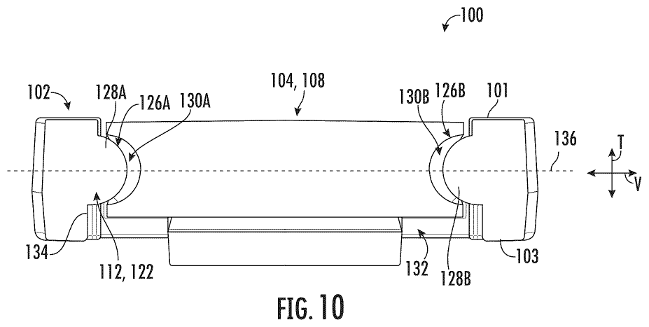

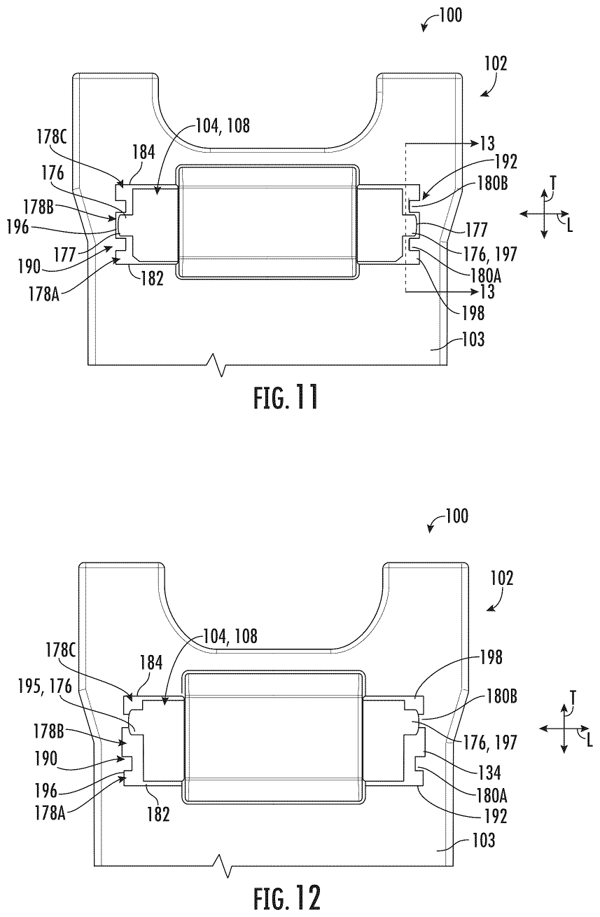

Referring specifically to FIG. 10, which illustrates a cross-sectional view of the solar cable decoupler tool 100 taken along line 10-10 shown in FIG. 8, a first ball and socket joint 126A and a second ball and socket joint 126B may couple the first tool member 108 to the main body 102. As shown, a first ball 128A and a second ball 128B may be defined by the main body 102, and a corresponding first socket 130A and second socket 130B may be defined by the tool member 108. A cavity 132 of the main body 102 may be defined by an interior wall 134 (which may be annular), and the first and second balls 128A, 128B may each be semi-spherically shaped and may extend in the transverse direction from the interior wall 134 into the cavity 132. Each of the first socket 130A and the second socket 130B of the tool member 108 may be semi-spherically shaped openings that correspond in size to the first and second balls 128A, 128B. The first ball 128A may extend into the first socket 130A, and the second ball 128B may extend into the second socket 130B. The first and second balls 128A, 128B and the first and second sockets 130A, 130B may be aligned along a rotational axis 136 (which may extend in the transverse direction T). Particularly, the apex of the balls 128A, 128B may each be positioned on the rotational axis 136. The ball and socket joints 126A, 126B restrict translational movement of the tool member 108 relative to the main body 102 but allows for rotational movement of the tool member 108 relative to the main body 102 about the coupling feature 112 (e.g., about the rotational axis 136).

It should be appreciated that the second tool member 110 may be similarly coupled to the main body 102 via a ball and socket joint 126. For example, as shown in FIG. 2, the second coupling feature 124 of the main body 102 may include or correspond to a pair of opposed balls 128 (one of which is shown in FIG. 2) extending from the main body 102 in the transverse direction T into a corresponding cavity 132, with the balls configured to be received within a corresponding pair of sockets 130 (one of which is shown in FIG. 2) of the second tool member 110 to allow such tool member 110 to be rotatably or pivotably coupled to the main body 102.

It should also be appreciated that, although the illustrated embodiment utilizes a ball and socket joint to rotatably or pivotably couple the tool members 108, 110 to the main body 102, any other suitable rotatable or pivotable connection may be provided between each tool member 108, 110 and the main body 102. For instance, in alternative embodiment, a pinned connection may be provided between the tool members 108, 110 and the main body 102.

Referring back to FIG. 2, each tool member 108, 110 may generally include a mounting portion 138 and a pair of arms 140 extending outwardly from the mounting portion 138 to form a forked configuration for the tool member 108, 110. For instance, in the illustrated embodiment, each arm 140 extends from a base 142 of the arm 140 positioned at or formed integrally with the mounting portion 138 to a respective tip 144 of the arm 140 positioned opposite or distal from the base 142. The mounting portion 138 of each tool member 108, 110 may be configured to be rotatably, and removably coupled to the main body 102. Particularly, the mounting portion 138 of each tool member 108, 110 may define the sockets 130 that couple the tool member to the respective pair of balls 128 of the main body 102. In one embodiment, the mounting portion 138 of each tool member 108, 110 may include a rounded end 146 extending between the sockets 130 to facilitate smooth rotational contact of the tool member 104 relative to the main body 102.

As shown in FIG. 2, the arms 140 of each tool member 108, 110 may be spaced apart from one another as they extend outwardly from the mounting portion 138 of the tool member 108, 110. Additionally, each of the arms 140 may include a straight portion 147 and a tapering portion 148 as the arm 140 extends outwardly from the mounting portion 138 from its base end 142 to its tip end 144. The straight portion 147 may extend (with generally constant width) from the base 142 to the tapering portion 148, and the tapering portion 148 may extend from the straight portion 147 to the tip 144. The tapering portion 148 may taper in width as the tapering portion 148 extends from the straight portion 147 to the tip 144. This allows for the arms 140 to engage the prongs 212 of a solar cable connector 206 (FIGS. 1A and B) and apply a force thereto to disconnect the pair of solar cables without breaking or causing damage to the prongs 212.

In many embodiments, each tool member 108, 110 may be rotatable about the respective coupling feature 122, 124 of the main body 102 (e.g., about the first and second ball and socket joints 126A, 126B and about the rotational axis 136) between a retracted position and an extended position. For example, as shown by FIGS. 3, 4, and 5, the first tool member 108 may be movable (e.g., rotatable) between a retracted position (FIG. 3), a first extended position (FIG. 4), and a second extended position (FIG. 5). Additionally, as shown by FIGS. 6 and 7, the second tool member 110 may be movable (e.g., rotatable) between a retracted position (FIG. 6) and an extended position (FIG. 7). In the retracted position, each tool member 108, 110 may extend generally parallel to the main body 102 (e.g., a centerline of each tool member 108, 110 may be parallel to a centerline of the main body 102).

In many embodiments, each tool member 108, 110 may include or define features for facilitating or assisting with rotation of the tool member 108, 110 relative to the main body 102 from its retracted position. For example, as shown in FIGS. 6 and 7, the mounting portion 138 of the second tool member 110 may include one or more ribs 150 (e.g., a pair of ribs) extending therefrom to facilitate rotation of the tool member 110 from the retracted position towards its extended position. As particularly shown in FIGS. 6 and 8, the ribs 150 extend outwardly from the mounting portion 138 and are generally parallel to each other. That is, the ribs 150 may extend or protrude outwardly from an exterior surface of the mounting portion 138 of the second tool member 110. The ribs 150 may be generally parallel to one another, spaced apart in the longitudinal direction L (when in the retracted position), and elongated in the transverse direction T. For example, the ribs 150 may be longest in the transverse direction T. The ribs 150 may be generally shaped as a rectangular prism (e.g., with chamfered or arcuate edges); however, it should be appreciated that other shapes are possible. When in the retracted position (FIG. 6), the ribs 150 extend generally vertically from the exterior surface of the mounting portion 138 and may each extend generally transversely from a first end to a second end (e.g., generally perpendicular to the longitudinal centerline 250). This orientation allows for a user to easily grasp the main body 102 and apply a force to the ribs 150 to move the tool member 108 between the retracted position and the extended position. That is, the ribs 150 may provide additional leverage that provides for increased friction when a user transitions the tool member 110 between the retracted position and the extended position. It should be appreciated that, in one embodiment, the first tool member 108 may also include ribs to help facilitate or assist a user when transitioning the tool member 108 from the retracted position to one of the extended positions.

Alternatively, or additionally, the arms 140 of one or both of the tool members 108, 110 may include protrusions to facilitate rotation of the tool member between the retracted and extended positions. For example, as shown in FIGS. 3, 4, and 5, at least one arm (such as both arms) of the pair of arms 140 of the first tool member 108 may include a protrusion 152 to facilitate rotation of the tool member between the retracted position and the extended position. Particularly, in the illustrated embodiment, each of the arms 140 of the first tool member 108 includes a protrusion 152 extending therefrom. When in the retracted position (FIG. 3), the protrusion 152 may extend generally longitudinally along the arm 140 to which the protrusion 152 is attached. Additionally, each protrusion 152 may extend generally transversely from its respective arm 140 to a free end. The protrusion 152 may be spaced apart (e.g., vertically spaced apart) from the main body 102 when the tool member is in the retracted position, such that a gap 154 (FIG. 3) is defined therebetween (e.g., a vertical gap). In this way, a user may grasp the main body 102 and use a finger or thumb to apply a force to the protrusion 152 in order to rotate the tool member 108 between the retracted position, the first extended position, and/or the second extended position. It should be appreciated that, in one embodiment, the second tool member 110 may also include protrusions extending from its arms to help facilitate or assist a user when transitioning the tool member 110 from the retracted position to the extended position.

In exemplary embodiments, each tool member 108, 110 may be removably couplable to the respective coupling feature 122, 124 of the main body 102. That is, both the first tool member 108 and the second tool member 110 may be disconnected or decoupled from the main body 102 without causing damage to the main body 102 and/or the tool members 108, 110. Particularly, each tool member 108, 110 may be removed when in the retracted position by applying a vertical force thereto. To facilitate the removable coupling of the tool members 108, 110 relative to the main body 102, each tool member 108, 110 may include a slot 156 or cutaway in the boundary wall that defines the socket 130. This slot 156 allows each tool member 108, 110 to be snapped onto or other installed relative to its respective coupling feature 122, 124 of the main body 102 when installing the tool member 108, 110 onto the main body 102 and also allows the tool member 108, 110 to be quickly and efficiently removed from the tool 100, when desired. Specifically, when installing the tool member 108, 110 relative to the main body 102, the tool member 108, 110 may be pressed against the main body 102 such that the balls 128 of the main body 102 are received within the sockets 130 of the tool member 108, 110, with the slots 156 providing clearance to allow the sockets 130 to be snapped downwardly onto the balls 128. Similarly, when removing the tool member 108, 110, the tool member may be pulled outwardly away from main body 102 to allow the sockets 130 to be decoupled form the balls 128. The removable coupling of the tool members 108, 110 relative to the main body 102 allows for a broken or worn tool member to be easily replaced without having to discard the entire solar cable decoupler tool 100. Additionally, the removable coupling of the tool members 108, 110 relative to the main body 102 allows for a newly sized tool member to replace an existing tool member in the event any newly sized solar cable connectors are introduced into the market.

In many embodiments, the main body 102 may define a respective recess 158 for receiving each tool member 108, 110, with each tool member 108, 110 being configured to extend at least partially within its associated recess 158 when in the retracted position. Additionally, each tool member 108, 110 may be configured to extend away from main body 102 (and/or its respective recess 158) when in the extended position. In general, each recess 158 may be sized and shaped to correspond with the shape of the respective tool member 108, 110. That is, the recess 158 may have a first portion to receive the mounting portion 138 of the respective tool member 108, 110 and a second portion to receive the arms 140 of the respective tool member 108, 110 when in the retracted position. In one embodiment, the recess may be sized larger than the tool member 108, 110 to allow for the tool member 108, 110 to be positioned therein without causing interference, such as 5% larger, or such as 10% larger, or such as 20% larger. Particularly, the main body 102 may define a first recess sized and shaped to correspond with the first tool member 108. Additionally, the main body 102 may define a second recess sized and shaped to correspond with the second tool member 110.

When the first tool member 108 is in the retracted position, the first tool member is oriented generally parallel to the main body 102 (e.g., an interior surface of the first tool member 108 may contact the exterior surface of the main body 102 within the associated recess 158). For example, as shown in FIG. 3, when in the retracted position, the arms 140 of the tool member 108 may generally extend outwardly from the mounting portion 138 of the tool member 108 in the longitudinal direction L toward the opposed end 116 (FIG. 2) of the tool 100. As shown in FIGS. 3 through 5, the first tool member 108 is movable from the retracted position (FIG. 3) to a first extended position (FIG. 4) or a second extended position (FIG. 5). In the retracted position, as shown in FIG. 3, the first tool member 108 forms a first angle with the main body 102 of about 0°. More particularly, an interior surface 166 (FIGS. 4 and 5) of the first tool member 108 and an exterior surface 168 (FIGS. 4 and 5) of the main body 102 may form the first angle of about 0° when in the retracted position, such that the interior surface 166 may contact the exterior surface 168 and/or generally extend parallel thereto. When in the first extended position, as shown in FIG. 4, the first tool member 108 forms a second angle with the main body 102 of about 90°. That is, the interior surface 166 of the first tool member 108 and the exterior surface 168 of the main body 102 may form the second angle of about 90° when in the first extended position. Lastly, when in the second extended position, as shown in FIG. 5, the first tool member 108 may form a third angle with the main body 102 of about 180°. That is, the interior surface 166 of the first tool member 108 and the exterior surface 168 of the main body 102 may form the third angle of about 180° when in the second extended position. The first and second extended positions may allow a user to have multiple options for leveraging the tool members 108 when disconnecting a solar cable connector 200. For example, the first extended position may allow a user to apply a force perpendicular to (or against) the elongated portion of the main body 102 when disconnecting the solar cable connector 200. By contrast, the second extended position may allow a user to apply a force parallel to (or along) the elongated portion of the main body 102. The multiple options for leveraging the tool members 108 when disconnecting a solar cable connector 200 can beneficially enable a user to select the most comfortable, accessible, or successful option for disconnecting a solar cable connector 200, particularly when working in confined and/or physically challenging spaces.

Similarly, as shown in FIGS. 6 and 7, the second tool member 110 is movable from the retracted position (FIG. 6) to an extended position (FIG. 7). In the retracted position, as shown in FIG. 6, the second tool member 110 forms a first angle with the main body 102 of about 0°. More particularly, an interior surface 166 (FIG. 7) of the second tool member 110 and an exterior surface 168 (FIG. 7) of the main body 102 may form the first angle of about 0° when in the retracted position, such that the interior surface 166 may contact the exterior surface 168 or generally extend parallel thereto. When in the extended position, the second tool member 110 forms the second angle with the main body 102 of about 90°. That is, the interior surface 166 of the second tool member 110 and the exterior surface 168 of the main body 102 may form the second angle of about 90° when in the extended position.

As shown in FIGS. 2 through 9, the first tool member 108 may be sized and configured to be inserted into a first sized solar cable connector. In such embodiments, the second tool member 110 may be sized and configured to be inserted into a second sized solar cable connector that is sized differently than the first sized solar cable connector. For example, the first tool member 108 may include differently sized and spaced arms 140 than the second tool member 110, and the first tool member 108 may be generally larger than the second tool member 110. As an example, the solar industry may include two differently sized, standard solar cable connectors. In such embodiments, the first tool member 108 may be sized and configured to decouple a standard solar cable connector of a first size and configuration, and the second tool member 110 may be sized and configured to decouple a standard solar cable connector of a second size and configuration.

In some embodiments, the main body 102 may further define a slot 174 that is sized to receive a strap. For example, the strap may be a hook and loop fastener that allows for the tool to be attached to a user's wrist, toolbelt, tool bag, etc. In the embodiments shown, the slot 174 may be defined between the second tool member 110 (or the second coupling feature 124) and the second end 116 of the main body 102. The slot 174 may be defined through the entire main body 102 and may be generally rectangularly shaped (although other shapes are possible).

Referring back to FIG. 2, briefly, each tool member 108, 110 may further include a pair of tabs 176, with each tab 176 extending outwardly from the mounting portion 138 of the tool member 108, 110 to a free end of such tab 176. The tabs 176 may generally be positioned at the rounded end 146 of the mounting portion 138 and may be configured to extend outwardly in the transverse direction T. Particularly, as shown in FIG. 2, the tabs 176 are generally configured to be positioned about the perimeter of the sockets 130 of the tool members 108, 110 such that each tab 176 extends outwardly from the mounting portion 138 of its associated tool member 108, 110 adjacent to a respective socket 130.

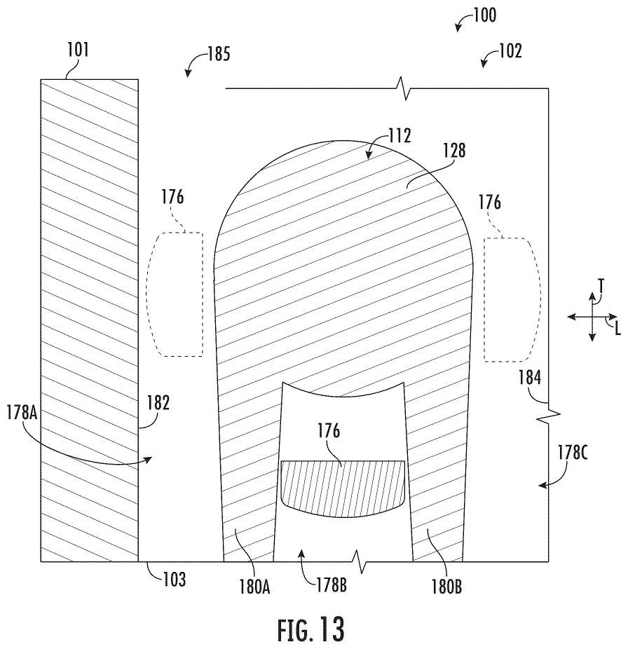

Referring now to FIGS. 11-13, various additional views of the solar decoupler tool 100 described above are illustrated in accordance with aspects of the present subject matter. Specifically, FIG. 11 illustrates an enlarged plan view of the second side 103 of the solar cable decoupler tool 100, in which the first tool member 108 is in a first extended position (e.g., corresponding with the position shown in FIG. 4). FIG. 12 illustrates an enlarged plan view of the second side 103 of the solar cable decoupler tool 100, in which the first tool member 108 is in a transitory position between the first extended position and the retracted position (e.g., a position between those shown in FIGS. 3 and 4), i.e., the first tool member 108 is being moved between the extended position and the retracted position (or vice versa). FIG. 13 illustrates a cross-sectional view of the solar cable decoupler tool 100 taken along line 13-13 shown in FIG. 11, in accordance with embodiments of the present disclosure.

In several embodiments, the main body 102 may define one or more detent channels 178A, 178B, 178C at the interface defined between the main body 102 and each tool member 108, 110. Specifically, the detent channels 178A, 178B, 178C may be provided at or adjacent to the coupling features 122, 124 defined by the main body 102 such that the tabs 176 of each tool member 108, 110 are configured to be selectively received or positioned within a respective set of detent channels 178A, 178B, 178C when tool member 108, 110 is installed relative to the main body 102 (and when such tool member 108, 110 is being pivoted relative to the main body 102). As shown in FIGS. 11 and 12, in several embodiments, the detent channels 178A, 178B, 178C may be at least partially defined by one or more ridges 180A, 180B extending outwardly from the main body 102 into the cavity within which the mounting portion 138 of the respective tool member 108, 110 is configured to be received. It should be appreciated that, in FIGS. 11 through 13, the detent channels 178A, 178B, 178C are shown as being defined at the interface between the main body 102 and the first tool member 108. However, a similar set of detent channels 178A, 178B, 178C may also be provided at the interface between the main body 102 and the second tool member 110 (e.g., see FIG. 8).

As indicated above, the one or more ridges 180A, 180B and/or the detent channels 178A, 178B, 178C may be provided or defined adjacent to (and at least partially defined by) the respective coupling features 122, 124 of the main body 102 (e.g., adjacent the balls 128). For example, as shown in FIGS. 11 and 12, the main body 102 may include a first side wall 182 spaced apart from the coupling feature 112, a first ridge 180A of the one or more ridges 180A, 180B extending from the coupling feature 112 (e.g., extending vertically from the ball 128 of the ball and socket joint 126), a second ridge 180B of the one or more ridges 180A, 180B extending from the coupling feature 112 (e.g., extending from the ball 128 of the ball and socket joint 126), and a second side wall 184 spaced apart from the coupling feature 112. The detent channels 178A, 178B, 178C may be defined between the ridges 180A, 180B and/or between a ridge 180A, 180B and a side wall 182, 184. For example, a first detent channel 178A may be defined between the first side wall 182 and the first ridge 180A. A second detent 178B channel may be defined between the first ridge 180A and the second ridge 180B. A third detent channel 178C may be defined between the second ridge 180B and the second side wall 184.

Additionally, as shown in FIGS. 11 and 12, the main body 102 may include a first set 190 of ridges 180A, 180B and corresponding detent channels 178A, 178B, 178C and a second set 192 of ridges 180A, 180B and corresponding detent channels 178A, 178B, 178C opposite the first set 190. The cavity 132 may be generally rectangularly shaped and may be defined collectively by the first side wall 182, the second side wall 184, a first interior wall 196, and a second interior wall 198. The first side wall 182 and the second side wall 184 may be spaced apart in the longitudinal direction L. Additionally, the first side wall 182 and the second side wall 184 may be generally parallel to one another in the transverse direction T. Similarly, the first interior wall 196 and the second interior wall 198 may be spaced apart in the transverse direction T. Further, the first interior wall 196 and the second interior wall 198 may extend generally parallel to one another in the longitudinal direction L between the first side wall 182 and the second side wall 184.

The first set 190 of ridges 180A, 180B may extend from the first interior wall 196 generally transversely into the cavity 132 and partially define corresponding detent channels 178A, 178B, 178C. Similarly, the second set 192 of ridges 180A, 180B may extend from the second interior wall 198 generally transversely into the cavity 132 and partially define corresponding detent channels 178A, 178B, 178C.

Furthermore, as shown in FIGS. 11 and 12, the flange 104 may include a first tab 195 (which extends transversely from the mounting portion). The first tab 195 may engage the first set 190 of ridges 180A, 180B and extend into one of the corresponding detent channels 178A, 178B, or 178C depending on the position of the flange 104. Similarly, the flange 104 may include a second tab 197 (which extends transversely from the mounting portion opposite the first tab 195). The second tab 197 may engage the second set 192 of ridges 180A, 180B and extend into one of the corresponding detent channels 178A, 178B, or 178C depending on the position of the flange 104.

As shown in FIGS. 11 and 12, each tab 176 of the associated tool member 108, 110 may extend from the mounting portion 138 to a terminal end 177, with the terminal end 177 of each tab 176 being rounded or arcuate to facilitate sliding of the tab over the ridges and between the detent channels. More specifically, as shown in FIG. 12 the terminal end 177 of each tab 176 contacts the ridges 180A, 180B when moving the tool member 104 between the extended position and the retracted position.

In FIGS. 11 and 13, the tool member 104 (e.g., the first tool member 108) may be in the first extended position (corresponding with the position shown in FIG. 4), such that the tabs 176 are positioned in the second detent channels 178B. Moving the tool member 104 between the positions (e.g., between the first extended position and the retracted position or the second extended position) causes the tabs 176 to move from the second detent channels 178B of the one or more detent channels 178A, 178B, 178C across the one or more ridges 180A, 180B into a different pair of detent channels of the one or more detent channels 178A, 178B, 178C. This process may be done from any detent channel to any detent channel. FIG. 13 illustrates a view of a tab 176 in dashed lines within each of the detent channels 178A, 178B, 178C. The first detent channel 178A (corresponding with the retracted position shown in FIG. 3) may include an opening 185 to allow for the tool member 104 to be removed or detached from the main body 102 as desired. The detent channels 178A, 178B, 178C and the associated tabs 176 advantageously allow the tool member 104 to maintain rigidity in each of the positions in order to be used for decoupling solar cables while still being capable of moving between each of the positions by an applied force from a user.

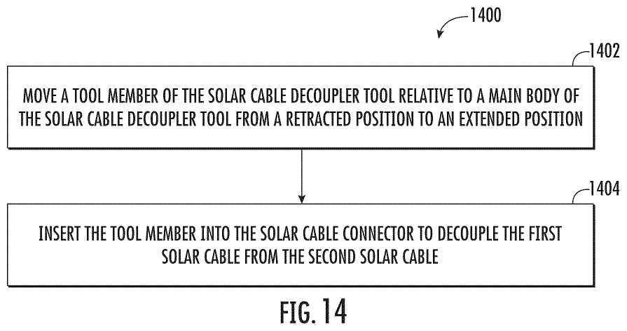

Referring now to FIG. 14, a flow diagram of one embodiment of a method 1400 of using a solar cable decoupler tool for decoupling solar cables is illustrated in accordance with embodiments of the present disclosure. In general, the method 1400 will be described herein with reference to the solar cable decoupler tool 100 and the solar cables 200 described above with reference to FIGS. 1 through 13. However, it will be appreciated by those of ordinary skill in the art that the disclosed method 1400 may generally be utilized with any tool used for solar cable decoupling having any other suitable configuration consistent with the disclosure provided herein. In addition, although FIG. 14 depicts steps performed in a particular order for purposes of illustration and discussion, the methods discussed herein are not limited to any particular order or arrangement unless otherwise specified in the claims. One skilled in the art, using the disclosures provided herein, will appreciate that various steps of the methods disclosed herein can be omitted, rearranged, combined, and/or adapted in various ways without deviating from the scope of the present disclosure. Dashed boxes indicate optional steps of the method 1400.

As shown in FIG. 14, the method 1400 may include at (1402) moving a tool member of the solar cable decoupler tool relative to a main body of the solar cable decoupler tool from a retracted position to an extended position. Moving at (1402) may include rotating the tool member relative to a coupling feature of the main body between the retracted position and the extended position. In various implementations, a tab of the tool member may move from a first detent channel across a ridge to a second detent channel while rotating the tool member between the retracted position and the extended position.

In exemplary implementations, the method 1400 may include at (1404) inserting the tool member into a solar cable connector to decouple a first solar cable and a second solar cable. The tool member may be inserted into the solar cable connector when in an extended position. A user may grasp a main body of the solar cable decoupler and insert arms of the tool member into a slot of the solar cable connector to engage prongs of the solar cable connector in order to decouple a male end of the solar cable connector from a female end of the solar cable connector. That is, the arms of the tool member may be inserted into the solar cable connector such that the arms apply a force to the prongs of the solar cable connector, which causes the prongs to compress and translate out of the slots, such that the male end can be disconnected from the female end, thereby decoupling the first and second solar cables from each other. For example, the method may include applying a force to prongs of the solar cable connector with the arms of the tool member, which causes the prongs to compress and translate out of the slots, thereby decoupling the first and second solar cables from each other.

In various implementations, the method may further include at decoupling the tool member from the main body after a period of use. For example, the tool member may be used for a period of time until it becomes worn and/or broken. Subsequently, the method 1400 may include at coupling a replacement tool member to the main body. This advantageously allows the worn tool member to be replaced without having to discard the entire solar cable decoupler tool. For example, the method may further include decoupling the tool member from the main body by disconnecting a prior ball and socket joint formed between the tool member and the main body; and coupling a replacement tool member to the main body by forming a new ball and socket joint between the replacement tool member and the main body. For example, the ball and socket joint may have a “snap fit” and the ball and socket joint may be able to formed or disformed via the application of moderate physical force.

Additionally, in many implementations, the method may include moving the tool member back to the retracted position once the cables have been decoupled, for example to protect the tool member. For example, the tool member may be rotated relative to the main body from the extended position back to the retracted position once the cables are decoupled. Subsequently, the solar cable decoupler tool may be stored. The retracted position may advantageously protect and preserve the life of the tool member (e.g., by preventing the arms of the tool member from being exposed to external forces). Additionally, the retracted position advantageously prevents the arms from causing injury to the user, e.g., when stored in a user's pocket.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

Further aspects of the invention are provided by the subject matter of the following clauses:

An example of a solar cable decoupler tool for decoupling solar cables is provided. The example solar cable decoupler tool may include a main body; and a tool member couplable to the main body, the tool member being movable relative to the main body between a retracted position and one or more extended positions, wherein the tool member is configured to be inserted into a solar cable connector to decouple a first solar cable from a second solar cable that is connectable with the first solar cable via the solar cable connector.

The solar cable decoupler tool as in any preceding clause, wherein the tool member is pivotably coupled to the main body such that the tool member is rotatable relative to the main body between the retracted position and the one or more extended positions.

The solar cable decoupler tool as in any preceding clause, wherein the tool member is removably couplable to the main body.

The solar cable decoupler tool as in any preceding clause, wherein the main body defines a recess, wherein the tool member extends at least partially within the recess when in the retracted position, and wherein the tool member extends outwardly from the main body when in the one or more extended positions.

The solar cable decoupler tool as in any preceding clause, wherein the tool member includes a mounting portion and a pair of arms, with each arm of the pair of arms extending from a base of the arm disposed at the mounting portion to a tip of the arm disposed opposite the base.

The solar cable decoupler tool as in any preceding clause, wherein the mounting portion includes one or more ribs to facilitate movement of the tool member between the retracted position and the extended position.

The solar cable decoupler tool as in any preceding clause, wherein at least one arm of the pair of arms includes a protrusion to facilitate movement of the tool member between the retracted position and the extended position.

The solar cable decoupler tool as in any preceding clause, wherein the tool member is a first tool member, and wherein the solar cable decoupler tool further comprises a second tool member couplable to the main body, the second tool member being movable relative to the main body between a retracted position and one or more extended positions.

The solar cable decoupler tool as in any preceding clause, wherein the first tool member is sized and configured to be inserted into a first sized solar cable connector, and wherein the second tool member is sized and configured to be inserted into a second sized solar cable connector that is sized differently than the first sized solar cable connector.

The solar cable decoupler tool as in any preceding clause, wherein the tool member is coupled to the main body via a coupling feature of the main body such that a ball and socket joint is formed between the tool member and the main body, wherein the coupling feature is one of a ball or a socket of the ball and socket joint, and wherein the tool member includes or defines the other of the ball or the socket of the ball and socket joint.

The solar cable decoupler tool as in any preceding clause, wherein the main body defines one or more detent channels, and wherein the tool member includes a tab configured to be positioned in the one or more detent channels.

The solar cable decoupler tool as in any preceding clause, wherein the one or more detent channels comprises a first detent channel and a second detent channel, and wherein the tool member is movable relative to the main body to selectively position the tab into one of the first detent channel or the second detent channel.

The solar cable decoupler tool as in any preceding clause, wherein the tab is positioned in the first detent channel when the tool member is at the retracted position and wherein the tab is positioned in the second detent channel when the tool member is at one of the one or more extended positions.

The solar cable decoupler tool as in any preceding clause, wherein the main body defines a slot that is sized to receive a strap.

The solar cable decoupler tool as in any preceding clause, wherein the one or more extended positions comprise a first extended position and a second extended position, wherein the tool member is movable relative to the main body between the first extended position and the second extended position.

The solar cable decoupler tool as in any preceding clause, wherein the tool member forms a first angle with the main body of about 0° when in the retracted position, wherein the tool member forms a second angle with the main body of about 90° when in the first extended position, and wherein the tool member forms a third angle with the main body of about 180° when in the second extended position.

Another example is a method of using a solar cable decoupler tool for decoupling first and second solar cables connected together via a solar cable connector. The method may include moving a tool member of the solar cable decoupler tool relative to a main body of the solar cable decoupler tool from a retracted position to an extended position; and inserting the tool member into the solar cable connector to decouple the first solar cable from the second solar cable.

The method may optionally include rotating the tool member relative to the main body between the retracted position and the extended position;

The method may optionally include moving the tool member relative to the main body from the extended position back to the retracted position to protect the tool member.

The method may optionally include decoupling the tool member from the main body; or coupling a replacement tool member to the main body via a ball and socket joint.

The method may optionally include applying a force to prongs of the solar cable connector with the arms of the tool member, which causes the prongs to compress and translate out of the slots, thereby decoupling the first and second solar cables from each other.

The method may optionally include decoupling the tool member from the main body by disconnecting a prior ball and socket joint formed between the tool member and the main body; and coupling a replacement tool member to the main body by forming a new ball and socket joint between the replacement tool member and the main body.

What is claimed is:

1. A solar cable decoupler tool for decoupling solar cables, the solar cable decoupler tool comprising:
a main body; and
a tool member couplable to the main body, the tool member being movable relative to the main body between a retracted position and one or more extended positions,
wherein the tool member is configured to be inserted into a solar cable connector to decouple a first solar cable from a second solar cable that is connectable with the first solar cable via the solar cable connector.

2. The solar cable decoupler tool as in claim 1, wherein the tool member is pivotably coupled to the main body such that the tool member is rotatable relative to the main body between the retracted position and the one or more extended positions.

3. The solar cable decoupler tool as in claim 1, wherein the tool member is removably couplable to the main body.

4. The solar cable decoupler tool as in claim 1, wherein the main body defines a recess, wherein the tool member extends at least partially within the recess when in the retracted position, and wherein the tool member extends outwardly from the main body when in the one or more extended positions.

5. The solar cable decoupler tool as in claim 1, wherein the tool member includes a mounting portion and a pair of arms, with each arm of the pair of arms extending from a base of the arm disposed at the mounting portion to a tip of the arm disposed opposite the base.

6. The solar cable decoupler tool as in claim 5, wherein the mounting portion includes one or more ribs to facilitate movement of the tool member between the retracted position and the extended position.

7. The solar cable decoupler tool as in claim 5, wherein at least one arm of the pair of arms includes a protrusion to facilitate movement of the tool member between the retracted position and the extended position.

8. The solar cable decoupler tool as in claim 1, wherein the tool member is a first tool member, and wherein the solar cable decoupler tool further comprises a second tool member couplable to the main body, the second tool member being movable relative to the main body between a retracted position and one or more extended positions.

9. The solar cable decoupler tool as in claim 8, wherein the first tool member is sized and configured to be inserted into a first sized solar cable connector, and wherein the second tool member is sized and configured to be inserted into a second sized solar cable connector that is sized differently than the first sized solar cable connector.

10. The solar cable decoupler tool as in claim 1, wherein the tool member is coupled to the main body via a coupling feature of the main body such that a ball and socket joint is formed between the tool member and the main body, wherein the coupling feature is one of a ball or a socket of the ball and socket joint, and wherein the tool member includes or defines the other of the ball or the socket of the ball and socket joint.

11. The solar cable decoupler tool as in claim 1, wherein the main body defines one or more detent channels, and wherein the tool member includes a tab configured to be positioned in the one or more detent channels.

12. The solar cable decoupler tool as in claim 11, wherein the one or more detent channels comprises a first detent channel and a second detent channel, and wherein the tool member is movable relative to the main body to selectively position the tab into one of the first detent channel or the second detent channel.

13. The solar cable decoupler tool as in claim 12, wherein the tab is positioned in the first detent channel when the tool member is at the retracted position and wherein the tab is positioned in the second detent channel when the tool member is at one of the one or more extended positions.

14. The solar cable decoupler tool as in claim 1, wherein the main body defines a slot that is sized to receive a strap.

15. The solar cable decoupler tool as in claim 1, wherein the one or more extended positions comprise a first extended position and a second extended position, and wherein the tool member is movable relative to the main body between the first extended position and the second extended position.

16. The solar cable decoupler tool as in claim 15, wherein the tool member forms a first angle with the main body of about 0° when in the retracted position, wherein the tool member forms a second angle with the main body of about 90° when in the first extended position, and wherein the tool member forms a third angle with the main body of about 180° when in the second extended position.

17. A method of using a solar cable decoupler tool for decoupling first and second solar cables connected together via a solar cable connector, the method comprising:
moving a tool member of the solar cable decoupler tool relative to a main body of the solar cable decoupler tool from a retracted position to an extended position; and
inserting the tool member into the solar cable connector to decouple the first solar cable from the second solar cable.

18. The method as in claim 17, wherein moving the tool member comprises:
rotating the tool member relative to the main body between the retracted position and the extended position.

19. The method as in claim 17, further comprising moving the tool member relative to the main body from the extended position back to the retracted position to protect the tool member.

20. The method as in claim 17, further comprising:
decoupling the tool member from the main body by disconnecting a prior ball and socket joint formed between the tool member and the main body; and
coupling a replacement tool member to the main body by forming a new ball and socket joint between the replacement tool member and the main body.
